(19) United States
(12) Patent Application Publication
(10) Pub. No.: US 2026/0128960 A1
(43) Pub. Date: May 7, 2026

(54) UPDATING TRAINING REFERENCE SIGNAL CONFIGURATIONS

(71) Applicant: QUALCOMM Incorporated, San Diego, CA (US)

(72) Inventors: Rajeev KUMAR, San Diego, CA (US); Hamed PEZESHKI, San Diego, CA (US)

(21) Appl. No.: 19/370,455

(22) Filed: Oct. 27, 2025

Related U.S. Application Data
(60) Provisional application No. 63/715,478, filed on Nov. 1, 2024.

(51) Int. Cl. H04L 41/16; H04W 24/02; H04W 24/10

(52) U.S. Cl. CPC H04L 41/16; H04W 24/02; H04W 24/10

(57) ABSTRACT

Methods, systems, and devices for wireless communications are described. The described techniques may enable a network entity to update a training data collection configuration for performing, logging, or reporting measurements of a set of training resources. For example, a user equipment (UE) may perform and log measurements of the set of training resources according to the training data collection configuration. The UE may indicate the logged measurements to the network entity, and the network entity may update the training data collection configuration, or may pause or initiate training data collection. Additionally, or alternatively, the UE may indicate a request for the network entity to update the training data collection configuration or to pause or initiate training data collection. The network entity may accordingly update the training data collection configuration.

### CROSS REFERENCE

The present Application for Patent claims benefit of U.S. Provisional Patent Application No. 63/715,478 by Kumar et al., entitled “UPDATING TRAINING REFERENCE SIGNAL CONFIGURATIONS,” filed Nov. 1, 2024, assigned to the assignee hereof, and expressly incorporated by reference herein.

### FIELD OF TECHNOLOGY

The following relates to wireless communications, including updating training reference signal configurations.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving first signaling indicating one or more training data collection configurations for performing measurements, logging measurements, reporting measurements, or any combination thereof, performing the measurements on one or more configured reference signals in accordance with the one or more training data collection configurations in accordance with the one or more training data collection configurations, transmitting a message requesting an update to the one or more training data collection configurations based on the performed measurements, and receiving, in response to the message, second signaling indicating for the UE to pause the one or more training data collection configurations, indicating for the UE to initiate the one or more training data collection configurations, or indicating the update to the one or more training data collection configurations.

A UE for wireless communications is described. The UE may include one or more memories storing processor executable code, and one or more processors coupled with the one or more memories. The one or more processors may individually or collectively be operable to execute the code to cause the UE to receive first signaling indicating one or more training data collection configurations for performing measurements, logging measurements, reporting measurements, or any combination thereof, perform the measurements on one or more configured reference signals in accordance with the one or more training data collection configurations in accordance with the one or more training data collection configurations, transmit a message requesting an update to the one or more training data collection configurations based on the performed measurements, and receive, in response to the message, second signaling indicating for the UE to pause the one or more training data collection configurations, indicating for the UE to initiate the one or more training data collection configurations, or indicating the update to the one or more training data collection configurations.

Another UE for wireless communications is described. The UE may include means for receiving first signaling indicating one or more training data collection configurations for performing measurements, logging measurements, reporting measurements, or any combination thereof, means for performing the measurements on one or more configured reference signals in accordance with the one or more training data collection configurations in accordance with the one or more training data collection configurations, means for transmitting a message requesting an update to the one or more training data collection configurations based on the performed measurements, and means for receiving, in response to the message, second signaling indicating for the UE to pause the one or more training data collection configurations, indicating for the UE to initiate the one or more training data collection configurations, or indicating the update to the one or more training data collection configurations.

A non-transitory computer-readable medium storing code for wireless communications is described. The code may include instructions executable by one or more processors to receive first signaling indicating one or more training data collection configurations for performing measurements, logging measurements, reporting measurements, or any combination thereof, perform the measurements on one or more configured reference signals in accordance with the one or more training data collection configurations in accordance with the one or more training data collection configurations, transmit a message requesting an update to the one or more training data collection configurations based on the performed measurements, and receive, in response to the message, second signaling indicating for the UE to pause the one or more training data collection configurations, indicating for the UE to initiate the one or more training data collection configurations, or indicating the update to the one or more training data collection configurations.

In some examples of the method, UEs, and non-transitory computer-readable medium described herein, the one or more training data collection configurations include one or more measurement configurations, one or more logging configurations for storing measurements based on one or more measurement configurations, one or more reporting configurations associated with determining a suitability of the one or more measurement configurations or a quality of the stored measurements, or any combination thereof.

In some examples of the method, UEs, and non-transitory computer-readable medium described herein, the one or measurement configurations include one or more channel state information reference signal (CSI-RS) resources, one or more CSI-RS resource sets, one or more synchronization signal or physical broadcast shared channel (SS/PBSCH) resources, one or more SS/PBSCH resource sets, one or more cells, one or more frequency resources, one or more positioning reference signals, or any combination thereof.

In some examples of the method, UEs, and non-transitory computer-readable medium described herein, the update to the one or more training data collection configurations includes a change associated with the one or more measurement configurations, a change associated with the one or more logging configurations, a change associated with the one or more reporting configurations, or any combination thereof.

In some examples of the method, UEs, and non-transitory computer-readable medium described herein, the message requesting the update indicates one or more indicators corresponding to the one or more measurement configurations.

Some examples of the method, UEs, and non-transitory computer-readable medium described herein may further include operations, features, means, or instructions for transmitting the message requesting the update to the one or more training data collection configurations may be based on the performed measurements satisfying one or more criteria.

Some examples of the method, UEs, and non-transitory computer-readable medium described herein may further include operations, features, means, or instructions for pausing the one or more training data collection configurations based at least on the performed measurements satisfying the one or more criteria.

In some examples of the method, UEs, and non-transitory computer-readable medium described herein, the message requesting the update indicates that the performed measurements satisfy the one or more criteria.

In some examples of the method, UEs, and non-transitory computer-readable medium described herein, the one or more criteria include satisfaction of one or more measurement thresholds associated with the performed measurements, identification of a redundancy associated with the performed measurements, satisfaction of a power consumption threshold, satisfaction of a power memory threshold, or any combination thereof.

In some examples of the method, UEs, and non-transitory computer-readable medium described herein, the message requesting the update includes an uplink control information (UCI) message, a medium access control-control element (MAC-CE), or a radio resource control (RRC) message.

A method for wireless communications by a network entity is described. The method may include outputting, to a UE, first signaling indicating one or more training data collection configurations for performing measurements, logging measurements, reporting measurements, or any combination thereof, obtaining a report indicating one or more measurements performed on one or more configured reference signals in accordance with the one or more training data collection configurations, and outputting second signaling indicating for the UE to pause the one or more training data collection configurations, indicating for the UE to initiate the one or more training data collection configurations, or indicating an update to the one or more training data collection configurations.

A network entity for wireless communications is described. The network entity may include one or more memories storing processor executable code, and one or more processors coupled with the one or more memories. The one or more processors may individually or collectively be operable to execute the code to cause the network entity to output, to a UE, first signaling indicating one or more training data collection configurations for performing measurements, logging measurements, reporting measurements, or any combination thereof, obtain a report indicating one or more measurements performed on one or more configured reference signals in accordance with the one or more training data collection configurations, and output second signaling indicating for the UE to pause the one or more training data collection configurations, indicating for the UE to initiate the one or more training data collection configurations, or indicating an update to the one or more training data collection configurations.

Another network entity for wireless communications is described. The network entity may include means for outputting, to a UE, first signaling indicating one or more training data collection configurations for performing measurements, logging measurements, reporting measurements, or any combination thereof, means for obtaining a report indicating one or more measurements performed on one or more configured reference signals in accordance with the one or more training data collection configurations, and means for outputting second signaling indicating for the UE to pause the one or more training data collection configurations, indicating for the UE to initiate the one or more training data collection configurations, or indicating an update to the one or more training data collection configurations.

A non-transitory computer-readable medium storing code for wireless communications is described. The code may include instructions executable by one or more processors to output, to a UE, first signaling indicating one or more training data collection configurations for performing measurements, logging measurements, reporting measurements, or any combination thereof, obtain a report indicating one or more measurements performed on one or more configured reference signals in accordance with the one or more training data collection configurations, and output second signaling indicating for the UE to pause the one or more training data collection configurations, indicating for the UE to initiate the one or more training data collection configurations, or indicating an update to the one or more training data collection configurations.

In some examples of the method, network entities, and non-transitory computer-readable medium described herein, the one or more training data collection configurations include one or more measurement configurations, one or more logging configuration for storing measurements based on one or more measurement configurations, one or more reporting configurations associated with determining a suitability of the one or more measurement configurations or a quality of the stored measurements, or any combination thereof.

In some examples of the method, network entities, and non-transitory computer-readable medium described herein, the one or measurement configurations include one or more CSI-RS resources, one or more CSI-RS resource sets, one or more SS/PBSCH resources, one or more SS/PBSCH resource sets, one or more cells, one or more frequency resources, one or more positioning reference signals, or any combination thereof.

In some examples of the method, network entities, and non-transitory computer-readable medium described herein, the update to the one or more training data collection configurations includes a change associated with the one or more measurement configurations, a change associated with the one or more logging configurations, a change associated with the one or more reporting configurations, or any combination thereof.

In some examples of the method, network entities, and non-transitory computer-readable medium described herein, the second signaling indicates one or more indicators corresponding to the one or more measurement configurations.

Some examples of the method, network entities, and non-transitory computer-readable medium described herein may further include operations, features, means, or instructions for outputting the second signaling may be based on the performed measurements satisfying one or more criteria.

In some examples of the method, network entities, and non-transitory computer-readable medium described herein, the one or more criteria include satisfaction of one or more measurement thresholds associated with the performed measurements, identification of a redundancy associated with the performed measurements, satisfaction of a power consumption threshold, satisfaction of a power memory threshold, or any combination thereof.

In some examples of the method, network entities, and non-transitory computer-readable medium described herein, the second signaling includes a DCI message, a MAC-CE, or a RRC message.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports updating training reference signal configurations in accordance with one or more aspects of the present disclosure.

FIG. 2 shows an example of a wireless communications system that supports updating training reference signal configurations in accordance with one or more aspects of the present disclosure.

FIG. 3 shows an example of a process flow that supports updating training reference signal configurations in accordance with one or more aspects of the present disclosure.

FIG. 4 shows an example of a process flow that supports updating training reference signal configurations in accordance with one or more aspects of the present disclosure.

FIGS. 5 and 6 show block diagrams of devices that support updating training reference signal configurations in accordance with one or more aspects of the present disclosure.

FIG. 7 shows a block diagram of a communications manager that supports updating training reference signal configurations in accordance with one or more aspects of the present disclosure.

FIG. 8 shows a diagram of a system including a device that supports updating training reference signal configurations in accordance with one or more aspects of the present disclosure.

FIGS. 9 and 10 show block diagrams of devices that support updating training reference signal configurations in accordance with one or more aspects of the present disclosure.

FIG. 11 shows a block diagram of a communications manager that supports updating training reference signal configurations in accordance with one or more aspects of the present disclosure.

FIG. 12 shows a diagram of a system including a device that supports updating training reference signal configurations in accordance with one or more aspects of the present disclosure.

FIGS. 13 and 14 show flowcharts illustrating methods that support updating training reference signal configurations in accordance with one or more aspects of the present disclosure.

### DETAILED DESCRIPTION

In some wireless communication systems, a user equipment (UE) may perform one or more measurements and may report the measurements to a network entity (e.g., for one or more beam management operations, such as selecting one or more beams for communications between the UE and the network entity). In some examples, the UE and/or the network entity may predict beam measurements for a first set of resources (e.g., a first set of channel state information (CSI) resources, synchronization signal block (SSB) resources, physical broadcast shared channel (PBSCH) resources, one or more cells, positioning reference signals, or frequency resources) based on measurements performed on a second set of resources. That is, the measurements of the second set of resources may be training data used to predict the measurements of the first set of resources.

The UE may perform logging of the performed measurements. As described herein, logging may refer to saving samples (e.g., multiple samples) for reporting to a network entity or using for model training (e.g., at a later time). In some examples, however, the first set of resources may be unsuitable for collecting training data (e.g., based on a quality or redundancy associated with measurements via the first set of resources).

Accordingly, techniques described herein may enable the network entity to update a training data collection configuration for performing, logging (e.g., storing), and/or reporting measurements of a set of training resources. For example, the UE may perform and log measurements of the set of training resources according to the training data collection configuration. The UE may indicate the logged measurements to the network entity, and the network entity may determine that the set of training resources is unsuitable. The network entity may accordingly update the training data collection configuration (e.g., update the set of training resources), or may pause or initiate training data collection. Additionally, or alternatively, the UE may determine, based on the logged measurements, that the set of training resources is unsuitable, and may indicate a request for the network entity to update the training data collection configuration or to pause or initiate training data collection. The network entity may accordingly update the training data collection configuration.

Aspects of the disclosure are initially described in the context of wireless communications systems. Aspects of the disclosure are further illustrated by and described with reference to process flows, apparatus diagrams, system diagrams, and flowcharts that relate to updating training reference signal configurations.

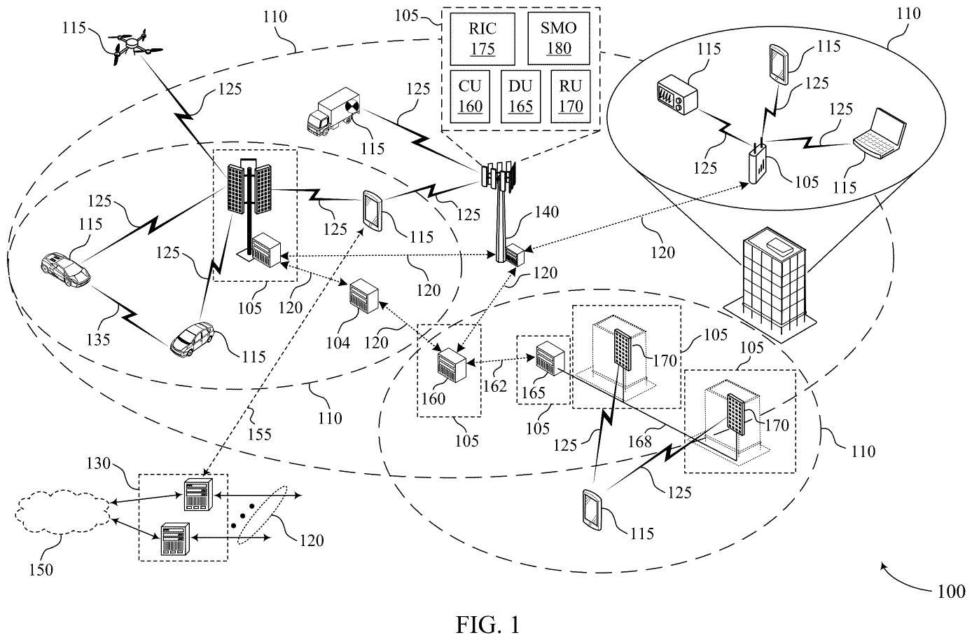

FIG. 1 shows an example of a wireless communications system 100 that supports updating training reference signal configurations in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L 3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1(L 1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support updating training reference signal configurations as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

Certain aspects and techniques as described herein may be implemented, at least in part, using an artificial intelligence (AI) program, such as a program that includes a ML or artificial neural network (ANN) model. An example ML model may include mathematical representations or define computing capabilities for making inferences from input data based on patterns or relationships identified in the input data. As used herein, the term “inferences” can include one or more of decisions, predictions, determinations, or values, which may represent outputs of the ML model. The computing capabilities may be defined in terms of certain parameters of the ML model, such as weights and biases. Weights may indicate relationships between certain input data and certain outputs of the ML model, and biases are offsets which may indicate a starting point for outputs of the ML model. An example ML model operating on input data may start at an initial output based on the biases and then update its output based on a combination of the input data and the weights.

In some aspects, an ML model may be configured to provide computing capabilities for wireless communications. Such an ML model may be configured with weights and biases to perform measurement prediction based on measured training data as described herein. Thus, during operation of a device, the ML model may receive input data (such as training data measured according to a training data collection configuration) and make inferences (such as a predicted measurements) based on the weights and biases.

ML models may be deployed in one or more devices (such as network entities 105 and UEs 115) and may be configured to enhance various aspects of a wireless communication system. For example, an ML model may be trained to identify patterns or relationships in data corresponding to a network, a device, an air interface, or the like. An ML model may support operational decisions relating to one or more aspects associated with wireless communications devices, networks, or services. For example, an ML model may be utilized for supporting or improving aspects such as signal coding/decoding, network routing, energy conservation, transceiver circuitry controls, frequency synchronization, timing synchronization channel state estimation, channel equalization, channel state feedback, modulation, demodulation, device positioning, beamforming, load balancing, operations and management functions, security, etc.

ML models may be characterized in terms of types of learning that generate specific types of learned models that perform specific types of tasks. For example, different types of machine learning include supervised learning, unsupervised learning, semi-supervised learning, reinforcement learning, etc. ML models may be used to perform different tasks such as classification or regression, where classification refers to determining one or more discrete output values from a set of predefined output values, and regression refers to determining continuous values which are not bounded by predefined output values. Some example ML models configured for performing such tasks include ANNs such as convolutional neural networks (CNNs) and recurrent neural networks (RNNs), transformers, diffusion models, regression analysis models (such as statistical models), large language models (LLMs), decision tree learning (such as predictive models), support vector networks (SVMs), and probabilistic graphical models (such as a Bayesian network), etc.

The description herein illustrates, by way of some examples, how one or more tasks or problems in wireless communications may benefit from the application of one or more ML models to predict measurements. To facilitate the discussion, an ML model configured using an ANN is used, but it should be understood, that other types of ML models may be used instead of an ANN. Hence, unless expressly recited, subject matter regarding an ML model is not necessarily intended to be limited to an ANN solution. Further, it should be understood that, unless otherwise specifically stated, terms such “AI/ML model,” “ML model,” “trained ML model,” “ANN,” “model,” “algorithm,” or the like are intended to be interchangeable.

In example aspects, an ML model may be trained prior to, or at some point following, operation of the ML model on input data. When training the ML model, information in the form of applicable training data may be gathered or otherwise created for use in training an ANN accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in a UE 115 or other device in a wireless communication system, or one or more network entities, or aggregated from multiple sources (such as a UE 115 and a network entity/entities 105, one or more other UEs 115, the Internet, or the like). For example, wireless network architectures, such as self-organizing networks (SONs) or mobile drive test (MDT) networks, may be adapted to support collection of data for ML model applications. In another example, training data may be generated or collected online, offline, or both online and offline by a UE, network entity, or other device(s), and all or part of such training data may be transferred or shared (in real or near-real time), such as through store and forward functions or the like.

Once an ANN has been configured by setting parameters, including weights and biases, from training data, the ANN's performance may be evaluated. In some scenarios, evaluation/verification tests may use a validation dataset, which may include data not in the training data, to compare the model's performance to baseline or other benchmark information. The ANN configuration may be further refined, for example, by changing the ANN configuration architecture, re-training the ANN configuration on the data, or using different optimization techniques, etc.

In some implementations, one or more devices or services may support processes relating to a ML model's usage, maintenance, activation, reporting, or the like. In certain instances, all or part of a dataset or model may be shared across multiple devices, to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions or improve performance relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a UE, a network entity such as a base station, or a disaggregated network entity such as a CU 160, a DU 165, a RU 170, or the like.

In some examples of the wireless communications system 100, a network entity 105 may configure a UE 115 with a training data collection configuration for performing, logging (e.g., storing), and/or reporting measurements of a set of training resources. The set of training data resources may be associated with prediction of measurements of a second set of resources. In some examples, the network entity 105 may update the training data collection configuration. For example, the UE 115 may perform and log measurements of the set of training resources according to the training data collection configuration. The UE 115 may indicate the logged measurements to the network entity 105, and the network entity 105 may determine that the set of training resources is unsuitable. The network entity 105 may accordingly update the training data collection configuration (e.g., update the set of training resources), or may pause or initiate training data collection at the UE 115. Additionally, or alternatively, the UE 115 may determine, based on the logged measurements, that the set of training resources is unsuitable, and may indicate a request for the network entity 105 to update the training data collection configuration or to pause or initiate training data collection. The network entity 105 may accordingly update the training data collection configuration.

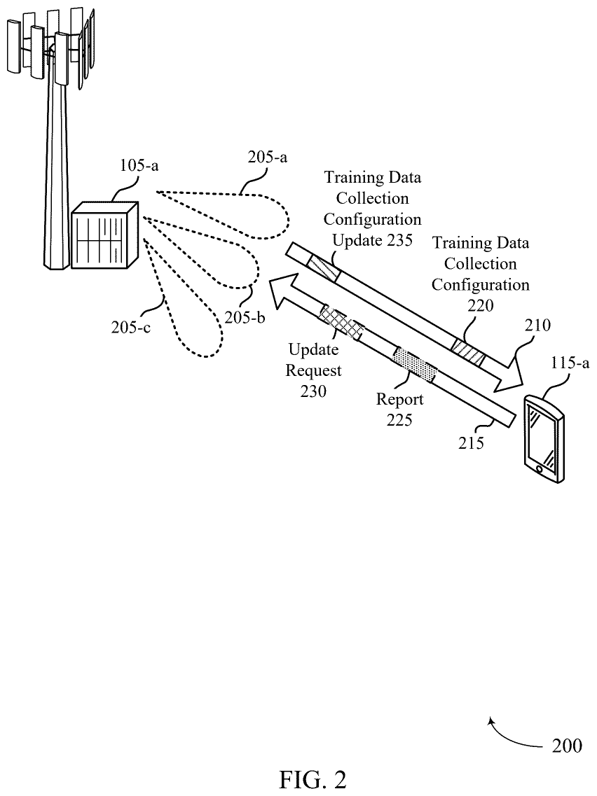

FIG. 2 shows an example of a wireless communications system 200 that supports updating training reference signal configurations in accordance with one or more aspects of the present disclosure. The wireless communications system 200 may implement or may be implemented by aspects of the wireless communications system 100. For example, the wireless communications system 200 may be implemented by a UE 115 (e.g., a UE 115-a) or a network entity 105 (e.g., a network entity 105-a), which may be examples of the corresponding devices as described with reference to FIG. 1.

In some examples of the wireless communications system 200, a UE 115-a may communicate with a network entity 105-a via one or more channels (e.g., an uplink channel 215 and a downlink channel 210). In some examples, the UE 115-a may perform one or more measurements via a first set of resources (e.g., via a set of beams 205, which may be referred to herein as Set B beams) and the UE 115-a or the network entity 105-a may compute predicted measurements associated with a second set of resources (e.g., a second set of beams, which may be referred to herein as Set A beams). For example, the UE 115-a may perform measurements on one or more reference signals (e.g., CSI-RSs, SSBs) via a beam 205-a and a beam 205-b and the UE 115-a or the network entity 105-a may predict measurements for a beam 205-c (e.g., without performing measurements via the beam 205-c).

In some examples, a quantity of resources in the first set of resources or in the second set of resources may be smaller than a first parameter (e.g., maxNrofNZP-CSI-RS-ResourcesPerSet for CSI-RS resources) per resource set. A total quantity of measurement resources (e.g., a sum of all periodic, aperiodic, and semi-persistent CSI-RS resources across all component carriers configured for reference signal received power (RSRP) measurements) may be smaller than a second parameter (e.g., maxNumberCSI-RS-Resource). That is, the second parameter may limit a quantity of total beams configured for CSI measurements (e.g., due to a capability of the UE 115-a to manage a quantity of transmission beams). A total quantity of measurement resources (e.g., a sum of all periodic, aperiodic, and semi-persistent CSI-RS or SSB resources across all component carriers configured for RSRP) measurement within a slot may be smaller than one or more third parameters (e.g., maxNumberSSB-CSI-RS-ResourceOneTx/TwoTx). That is, the one or more third parameters may limit a quantity of total beams configured for measurements in a single slot (e.g., due to real-time measurements or channel estimation capabilities of the UE 115-a within a slot). Accordingly, the quantity of resources in the second set of resources may be associated with the first parameter and the second parameter (e.g., and may not be limited by the third parameter).

In some examples, the UE 115-a or the network entity 105-a may predict the measurements using an AI or ML model (e.g., a model that is trained using the performed measurements associated with the first set of resources). In examples in which the model is trained by the network entity 105-a, the UE 115-a may use an MDT framework (e.g., an intermediate MDT framework for operations and management (OAM)-centric data collection). In some examples, the MDT framework may be adapted to support periodical reporting of measurements of the first set of resources.

In some examples, for spatial downlink measurement prediction, the first set or resources may be associated with relatively more wide beams (e.g., SSB or SSB-like beams) and the second set of resources may be associated with relatively more narrow beams (e.g., CSI-RS or CSI-RS-like beams). Additionally, or alternatively, the first set of resources may be associated with a first set of relatively more narrow beams, and the second set of resources may be associated with a second set of relatively more narrow beams.

For temporal downlink measurement prediction, the UE 115-a or the network entity 105-a may predict measurements of the second set of resources based on historic measurements (e.g., measurements taken relatively earlier in time) of the first set of resources. In some examples, the first set of resources may be associated with a same set of beams as the second set of resources (e.g., for beam prediction that is temporal and not spatial). In some examples, the first set of resources may be associated with a different set of beams from the second set of resources (e.g., for beam prediction that is temporal and spatial).

In some examples, an identifier (ID) (e.g., an associated ID) may be associated with the first set of resources and the second set of resources. Accordingly, the network entity 105-a and the UE 115-a may consistently associate the training resources (e.g., the first set of resources) with the inference resources (e.g., the second set of resources). In some examples, the first set of resources and the second set of resources may be CSI resources, synchronization signal (SS)/PBSCH resources, cells, positioning reference signals, or frequency resources. In some examples, measurement prediction techniques described herein may be used for single-cell scenarios (e.g., scenarios in which the UE 115-a communicates in a single cell of the network entity 105-a).

The network entity 105-a may transmit one or more training data collection configurations 220 to the UE 115-a. For example, the one or more training data collection configurations 220 may include one or more measurement configurations for performing measurements on the first set of resources (e.g., indicating the ID associated with the first set of resources), one or more logging configurations associated with storing the measurements of the first set of resources, and/or one or more reporting configurations associated with reporting the logged measurements to the network entity 105-a (e.g., via an RRC message).

The UE 115-a may perform measurements of the first set of resources according to one or more measurement configurations, may store the performed measurements according to the one or more logging configuration, and may report the performed measurements to the network entity 105-a (e.g., via a report 225) according to the one or more reporting configurations. The UE 115-a and the network entity 105-a may accordingly use the performed measurements to train an AI or ML model to predict measurements associated with the second set of resources. In some examples, the UE 115-a may report multiple instances perform and log a first set of measurements of the first set of resources according to a first measurement configuration and may perform and log a second set of measurements of the first set of resources according to a second measurement configuration (e.g., at a later time). The UE 115-a may report the first set of measurements and the second set of measurements together (e.g., via a report 225).

In some examples, one or more of the measurement configurations (e.g., the first set of resources, the measurements performed via the first set of resources) may be unsuitable for measurement predication. For example, the network entity 105-a or the UE 115-a may determine that the measurement configurations are unsuitable if the performed measurements satisfy one or more thresholds (e.g., RSRP or SNR thresholds) for a period of time (e.g., for a threshold duration), if the UE 115-a is mobile (e.g., if the UE 115-a may move out of an area associated with beams of the first set of resources based on a speed of the UE 115-a), or if measurements of the first set of resources are redundant (e.g., and may therefore not provide a suitable set of training data for the ML or AI model).

The network entity 105-a or the UE 115-a may therefore evaluate a suitability of the first set of resources for measurement prediction (e.g., prior to using the performed measurements to train the AI or ML model). For example, the network entity 105-a or the UE 115-a may determine if the measurements of the first set of resources satisfy one or more criteria, such as an SNR threshold or a redundancy. Additionally, or alternatively, the UE 115-a or the network entity 105-a may determine that the UE 115-a has satisfied a power consumption threshold or a power memory threshold.

In some examples, however, the UE 115-a may continue to perform measurements according to the one or more measurement configurations when the one or more measurement configurations are unsuitable (e.g., as compared to CSI measurements that are reported without logging, which may be updated by the network entity 105-a in real-time). Such techniques may result in increased power consumption and degraded quality of communications (e.g., as a result of performing and logging measurements that may not result in an accurate measurement prediction of the second set of resources). In some examples, the UE 115-a may be configured to measure relatively larger sets of resources (e.g., including relatively more beams or CSI-RS resources, such as 256 beams or CSI-RS resources) to obtain training and performance monitoring data, such that at least a subset of the first set of resources may be suitable for training. The UE 115-a may therefore report a relatively larger quantity of measurements (e.g., measurements of the relatively larger resource set), such that a quantity of reported beams may be equal to the quantity of beams in the relatively larger resource set.

However, some UEs 115 may have a capability to measure and report relatively smaller sets of resources (e.g., 0, 8, 16, 32, or 64 resources, rather than 256 resources), and may therefore not measure and report the relatively larger sets of resources. That is, increasing a quantity of resources (e.g., CSI resources) available for measurement and reporting may not increase a quantity of resources that the UE 115-a may be capable of measuring.

Accordingly, in some aspects, the network entity 105-a may update the training data collection configuration 220 (e.g., if the UE 115-a does not support measurement and reporting on the relatively larger set of resources for training data collection). That is, if the UE 115-a is performing measurements, logging measurements, and/or reporting measurements for training an AI or ML model (e.g., at the UE 115-a or at the network entity 105-a), the network entity 105-a may determine to update the training data collection configuration 220. The network entity 105-a may therefore configure the UE 115-a with resources for reporting the logged measurements for determining a suitability of the training data collection configuration 220 or resources for providing a request for the network entity 105-a to update or pause the training data collection configuration 220.

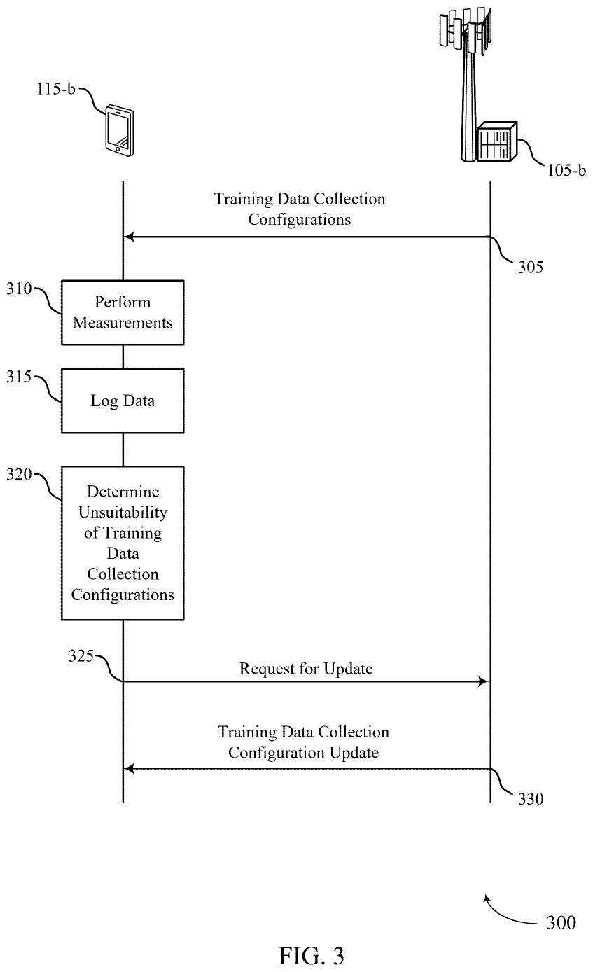

For example, if the UE 115-a or the network entity 105-a determines that the training data collection configuration 220 is unsuitable, the network entity 105-a may transmit a training data collection configuration update 235 to the UE 115-a. In some examples (e.g., if the UE 115-a performs an evaluation of the training data collection configuration), the UE 115-a may determine that the training data collection configuration 220 is unsuitable or redundant. The UE 115-a may transmit an update request 230 (e.g., an uplink control information (UCI), RRC, or medium access control-control element (MAC-CE) message) to the network entity 105-a in response to determining that the training data collection configuration 220 is unsuitable. The network entity 105-a may transmit the training data collection configuration update 235 in response to the update request. In some examples, the network entity 105-a and/or the UE 115-a may pause or initiate collection of training data (e.g., may pause or initiate training of the ML or AI model) at the UE 115-a or the network entity 105-a in response to determining that the training data collection configuration 220 is unsuitable, in response to the update request 230, and/or in response to the training data collection configuration update 235. Such techniques are described herein with reference to FIG. 3.

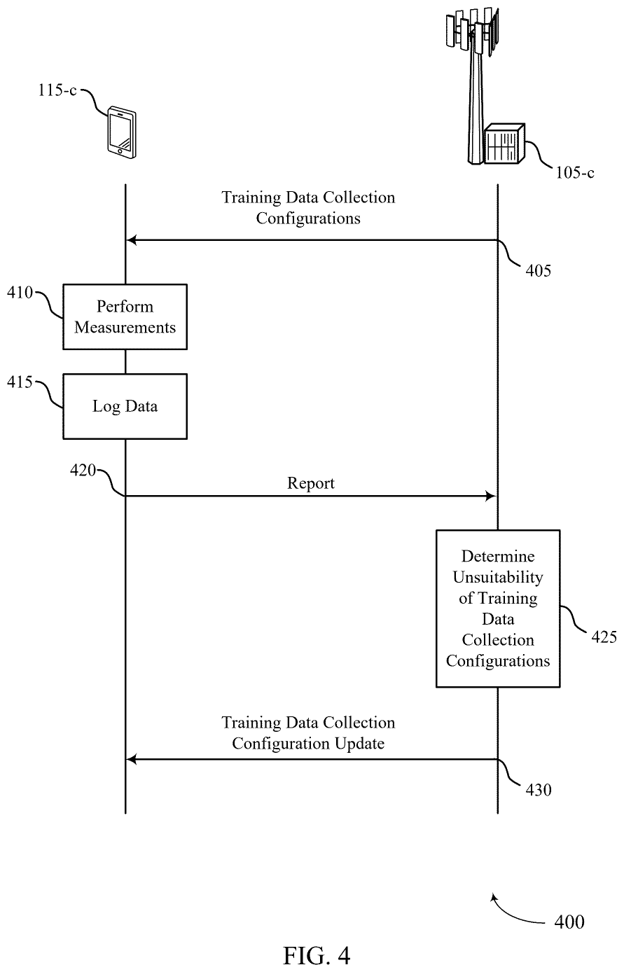

Additionally, or alternatively, the UE 115-a may transmit a report 225 (e.g., an L1 report, such as a CIS report) to the network entity 105-a indicating the measurements performed according to the training data collection configuration 220 (e.g., via the configured reporting resources). The report 225 (e.g., a report associated with determining if the training data collection configuration is suitable) may be semi-persistent or aperiodic. The network entity 105-a may evaluate the performed measurements and may determine that the training data collection configuration 220 is unsuitable. The network entity 105-a may accordingly transmit the training data collection configuration update 235 in response to determining that the training data collection configuration 220 is unsuitable. In some examples, the network entity 105-a may pause or initiate collection of training data at the UE 115-a or the network entity 105-a in response to determining that the training data collection configuration 220 is unsuitable (e.g., via the training data collection configuration update 235). Such techniques are described herein with reference to FIG. 4.

FIG. 3 shows an example of a process flow 300 that supports updating training reference signal configurations in accordance with one or more aspects of the present disclosure. The process flow 300 may implement or may be implemented by aspects of the wireless communications system 100 or the wireless communications system 200. For example, the process flow 300 may be implemented by a UE 115 (e.g., a UE 115-b) or a network entity 105 (e.g., a network entity 105-b), which may be examples of the corresponding devices as described with reference to FIG. 1.

In the following description of the process flow 300, the operations between the UE 115-b and the network entity 105-b may occur in a different order than the example order shown and, in some examples, may be performed by one or more different devices other than those shown as examples. Some operations also may be omitted from the process flow 300, and other operations may be added to the process flow 300. Further, although some operations or signaling may be shown to occur at different times for discussion purposes, these operations may actually occur at the same time.

At 305, the network entity 105-b may transmit first signaling to the UE 115-b indicating one or more training data collection configurations (e.g., training CSI-RS configurations, L3 logging or reporting configurations, L1 CSI reporting configurations, and the like). The one or more training data collection configurations may include configurations for performing measurements of training data, logging (e.g., storing) the measurements of the training data, reporting the measurements of the training data, and the like.

For example, the one or more training data collection configurations may include one or more measurement configurations for performing the measurements, which may include one or more CSI-RS resources or sets of CSI-RS resources, one or more SS/PBSCH resources or sets of SS/PBSCH resources, one or more frequency resources, one or more cells, or one or more positioning reference signals via which the UE 115-b may perform the measurements. Additionally, or alternatively, the one or more training data collection configurations may include one or more logging configurations for storing the measurements performed based on the one or more measurement configurations and/or one or more reporting configurations for reporting the performed measurements or a subset of the performed measurements to the network entity 105-c for training (e.g., for determining a suitability of the one or more measurement configurations or the stored measurements).

At 310, the UE 115-b may perform the measurements in accordance with the one or more training data collection configurations. For example, the UE 115-b may perform measurements of the one or more CSI-RS resources or sets of CSI-RS resources, one or more SS/PBSCH resources or sets of SS/PBSCH resources, one or more frequency resources, one or more cells, or one or more positioning reference signals. In some examples, the performed measurements may be associated with predicting one or more measurements of a second set of resources (e.g., via a ML model). For example, the UE 115-b may input the performed measurements into an ML model to generate one or more predicted measurements of the second set of resources.

At 315, the UE 115-b may log (e.g., store) the performed measurements in accordance with the one or more logging configurations. For example, the UE 115-b may log the measurements for future use in performing measurement prediction, reporting to the network entity 105-b, and the like.

At 320, the UE 115-b may determine that the one or more training data collection configurations may be unsuitable or that training data collection at the UE 115-b should be paused. For example, the UE 115-b may determine that one or more of the resources indicated by the one or more measurement configurations are unsuitable for measurement prediction based on the performed measurements. In some examples, the UE 115-b may pause the one or more training data collection configurations (e.g., refrain from performing additional measurements associated with the one or more training data collection configurations) in response to determining that the one or more training data collection configurations may be unsuitable.

In some examples, the UE 115-b may determine that the one or more training data collection configurations are unsuitable based satisfaction of one or more criteria, such as satisfaction of one or more measurement thresholds (e.g., a SNR threshold) associated with the performed measurements, identification of a redundancy associated with the performed measurements, satisfaction of a power consumption threshold of the UE 115-b, and/or satisfaction of a power memory threshold of the UE 115-b.

At 325, the UE 115-b may transmit a message to the network entity 105-b indicating a flag (e.g., a request for an update to the one or more training data collection configurations, for the network entity 105-b to pause the one or more training data collection configurations, and/or for the network entity 105-b to initiate the one or more training data collection configurations) in response to determining that the one or more training data collection configurations are unsuitable and/or determining to pause the one or more training data collection configuration. In some examples, the message may be a UCI, RRC, or MAC-CE message.

In some examples, the message may indicate one or more identifiers associated with one or more measurement configurations of the one or more training data collection configurations that the UE 115-b requests to be updated, paused, or initiated. In some examples, the message may indicate the measurements (e.g., radio measurements, latest measurements on the configured resources for training, and/or all measurements logged by the UE 115-b). In some examples, the message may indicate a cause for pausing the training data collection configuration (e.g., an indication that the one or more criteria are satisfied).

At 330, the network entity 105-b may transmit second signaling to the UE 115-b indicating the update to the one or more training data collection configurations, indicating for the UE 115-b to pause the one or more training data collection configurations, and/or indicating for the UE 115-b to initiate the one or more training data collection configurations (e.g., an update, a pause indication, or a start indication in response to the request and/or in response to the reported measurements). The second signaling may be, for example, a DCI, RRC, or MAC-CE message. In some examples, the second signaling may indicate one or more identifiers associated with one or more measurement configurations of the one or more training data collection configurations that the network entity 105-b is updating, pausing, or initiating. The UE 115-b may therefore use an updated training data collection configuration to continue performing training data collection (e.g., for training an AI or ML model for measurement prediction at the UE 115-b or the network entity 105-b)

FIG. 4 shows an example of a process flow 400 that supports updating training reference signal configurations in accordance with one or more aspects of the present disclosure. The process flow 400 may implement or may be implemented by aspects of the wireless communications system 100, the wireless communications system 200, or the process flow 300. For example, the process flow 400 may be implemented by a UE 115 (e.g., a UE 115-c) or a network entity 105 (e.g., a network entity 105-c), which may be examples of the corresponding devices as described with reference to FIG. 1.

In the following description of the process flow 400, the operations between the UE 115-c and the network entity 105-c may occur in a different order than the example order shown and, in some examples, may be performed by one or more different devices other than those shown as examples. Some operations also may be omitted from the process flow 400, and other operations may be added to the process flow 400. Further, although some operations or signaling may be shown to occur at different times for discussion purposes, these operations may actually occur at the same time.

At 405, the network entity 105-c may transmit first signaling to the UE 115-c indicating one or more training data collection configurations (e.g., training CSI-RS configurations, L3 logging or reporting configurations, L1 CSI reporting configurations, and the like). The one or more training data collection configurations may include configurations for performing measurements of training data, logging (e.g., storing) the measurements of the training data, reporting the measurements of the training data, and the like.

For example, the one or more training data collection configurations may include one or more measurement configurations for performing the measurements, which may include one or more CSI-RS resources or sets of CSI-RS resources, one or more SS/PBSCH resources or sets of SS/PBSCH resources, one or more frequency resources, one or more cells, or one or more positioning reference signals via which the UE 115-b may perform the measurements. Additionally, or alternatively, the one or more training data collection configurations may include one or more logging configurations for storing the measurements performed based on the one or more measurement configurations and/or one or more reporting configurations for reporting the performed measurements or a subset of the performed measurements to the network entity 105-c for training (e.g., semi-persistent or aperiodic reporting over UCI, MAC-CE, or RRC for determining a suitability of the one or more measurement configurations or the stored measurements).

At 410, the UE 115-c may perform the measurements in accordance with the one or more training data collection configurations. For example, the UE 115-c may perform measurements of the one or more CSI-RS resources or sets of CSI-RS resources, one or more SS/PBSCH resources or sets of SS/PBSCH resources, one or more frequency resources, one or more cells, or one or more positioning reference signals. In some examples, the performed measurements may be associated with predicting one or more measurements of a second set of resources (e.g., via a ML model). For example, the UE 115-c may input the performed measurements into an ML model to generate one or more predicted measurements of the second set of resources.

At 415, the UE 115-c may log (e.g., store) the performed measurements in accordance with the one or more logging configurations. For example, the UE 115-c may log the measurements for future use in performing measurement prediction, reporting to the network entity 105-c, and the like.

At 420, the UE 115-c may transmit a message to the network entity 105-c including a report (e.g., a CSI report) indicating the performed measurements (e.g., measurements performed according to the one or more measurement configurations for training and/or on other CSI resources). For example, the UE 115-c may transmit the report to the network entity 105-c in accordance with the one or more reporting configurations.

At 425, the network entity 105-c may determine that the one or more training data collection configurations may be unsuitable or that training data collection at the UE 115-c should be paused. For example, the network entity 105-c may determine that one or more of the resources indicated by the one or more measurement configurations are unsuitable for measurement prediction based on the performed measurements.

In some examples, the network entity 105-c may determine that the one or more training data collection configurations are unsuitable based satisfaction of one or more criteria, such as satisfaction of one or more measurement thresholds (e.g., a SNR threshold) associated with the performed measurements, identification of a redundancy associated with the performed measurements, satisfaction of a power consumption threshold of the UE 115-c, and/or satisfaction of a power memory threshold of the UE 115-c.

At 430, the network entity 105-c may transmit second signaling to the UE 115-c indicating an update to the one or more training data collection configurations, indicating for the UE 115-c to pause the one or more training data collection configurations, and/or indicating for the UE 115-c to initiate the one or more training data collection configurations (e.g., an update, a pause indication, or a start indication in response to determining that the one or more training data collection configurations are unsuitable). The second signaling may be, for example, a DCI, RRC, or MAC-CE message. In some examples, the second signaling may indicate one or more identifiers associated with one or more measurement configurations of the one or more training data collection configurations that the network entity 105-c is updating, pausing, or initiating. The UE 115-c may therefore use an updated training data collection configuration to continue performing training data collection (e.g., for training an AI or ML model for measurement prediction at the UE 115-c or the network entity 105-c).

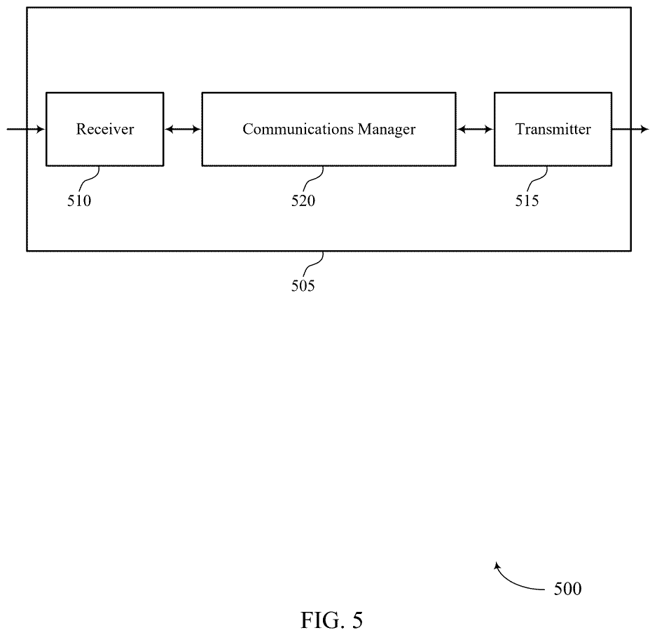

FIG. 5 shows a block diagram 500 of a device 505 that supports updating training reference signal configurations in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to updating training reference signal configurations). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to updating training reference signal configurations). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of updating training reference signal configurations as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving first signaling indicating one or more training data collection configurations for performing measurements, logging measurements, reporting measurements, or any combination thereof. The communications manager 520 is capable of, configured to, or operable to support a means for performing the measurements on one or more configured reference signals in accordance with the one or more training data collection configurations in accordance with the one or more training data collection configurations. The communications manager 520 is capable of, configured to, or operable to support a means for transmitting a message requesting an update to the one or more training data collection configurations based on the performed measurements. The communications manager 520 is capable of, configured to, or operable to support a means for receiving, in response to the message, second signaling indicating for the UE to pause the one or more training data collection configurations, indicating for the UE to initiate the one or more training data collection configurations, or indicating the update to the one or more training data collection configurations.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for updating a training data collection configuration, which may result in more efficient utilization of communication resources.

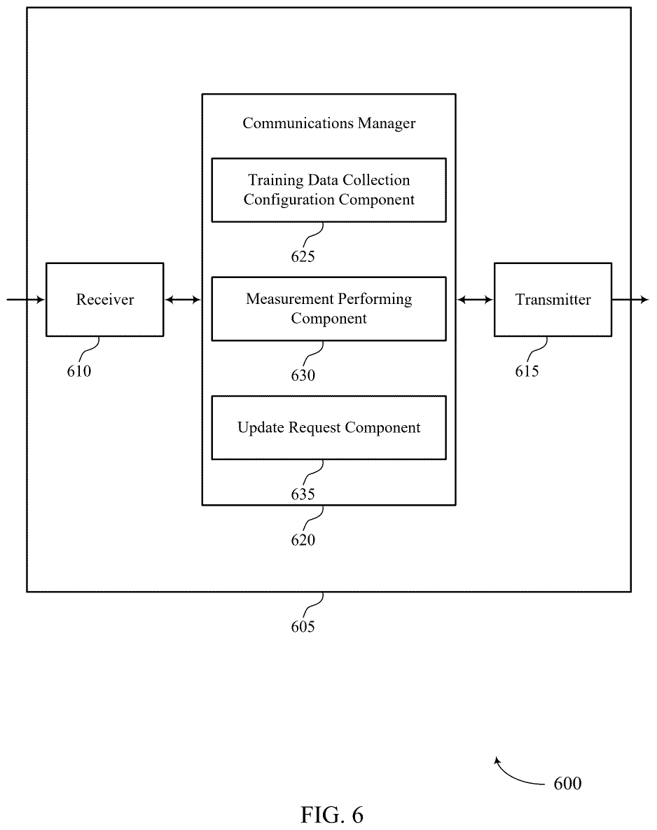

FIG. 6 shows a block diagram 600 of a device 605 that supports updating training reference signal configurations in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to updating training reference signal configurations). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to updating training reference signal configurations). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of updating training reference signal configurations as described herein. For example, the communications manager 620 may include a training data collection configuration component 625, a measurement performing component 630, an update request component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The training data collection configuration component 625 is capable of, configured to, or operable to support a means for receiving first signaling indicating one or more training data collection configurations for performing measurements, logging measurements, reporting measurements, or any combination thereof. The measurement performing component 630 is capable of, configured to, or operable to support a means for performing the measurements on one or more configured reference signals in accordance with the one or more training data collection configurations in accordance with the one or more training data collection configurations. The update request component 635 is capable of, configured to, or operable to support a means for transmitting a message requesting an update to the one or more training data collection configurations based on the performed measurements. The training data collection configuration component 625 is capable of, configured to, or operable to support a means for receiving, in response to the message, second signaling indicating for the UE to pause the one or more training data collection configurations, indicating for the UE to initiate the one or more training data collection configurations, or indicating the update to the one or more training data collection configurations.

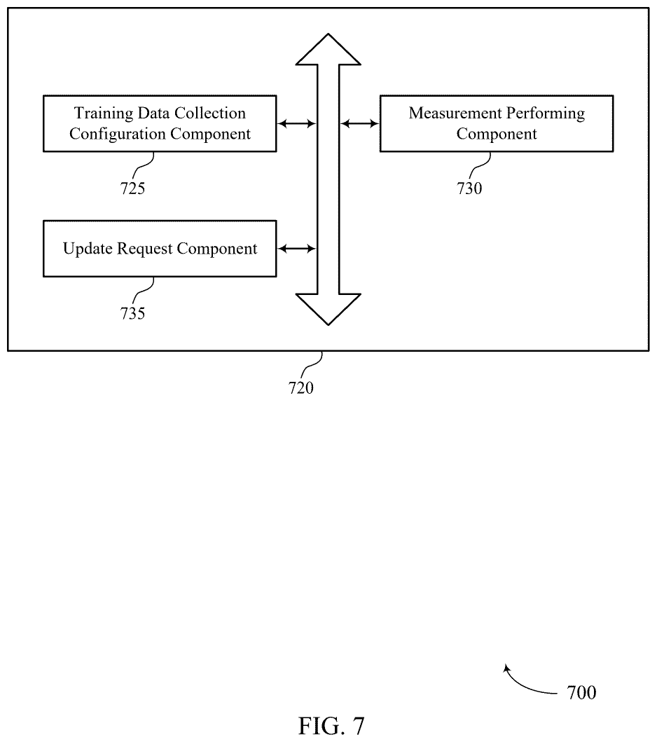

FIG. 7 shows a block diagram 700 of a communications manager 720 that supports updating training reference signal configurations in accordance with one or more aspects of the present disclosure. The communications manager 720 may be an example of aspects of a communications manager 520, a communications manager 620, or both, as described herein. The communications manager 720, or various components thereof, may be an example of means for performing various aspects of updating training reference signal configurations as described herein. For example, the communications manager 720 may include a training data collection configuration component 725, a measurement performing component 730, an update request component 735, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The training data collection configuration component 725 is capable of, configured to, or operable to support a means for receiving first signaling indicating one or more training data collection configurations for performing measurements, logging measurements, reporting measurements, or any combination thereof. The measurement performing component 730 is capable of, configured to, or operable to support a means for performing the measurements on one or more configured reference signals in accordance with the one or more training data collection configurations in accordance with the one or more training data collection configurations. The update request component 735 is capable of, configured to, or operable to support a means for transmitting a message requesting an update to the one or more training data collection configurations based on the performed measurements. In some examples, the training data collection configuration component 725 is capable of, configured to, or operable to support a means for receiving, in response to the message, second signaling indicating for the UE to pause the one or more training data collection configurations, indicating for the UE to initiate the one or more training data collection configurations, or indicating the update to the one or more training data collection configurations.

In some examples, the one or more training data collection configurations include one or more measurement configurations, one or more logging configurations for storing measurements based on one or more measurement configurations, one or more reporting configurations associated with determining a suitability of the one or more measurement configurations or a quality of the stored measurements, or any combination thereof.

In some examples, the one or measurement configurations include one or more CSI-RS resources, one or more CSI-RS resource sets, one or more SS/PBSCH resources, one or more SS/PBSCH resource sets, one or more cells, one or more frequency resources, one or more positioning reference signals, or any combination thereof.

In some examples, the update to the one or more training data collection configurations includes a change associated with the one or more measurement configurations, a change associated with the one or more logging configurations, a change associated with the one or more reporting configurations, or any combination thereof.

In some examples, the message requesting the update indicates one or more indicators corresponding to the one or more measurement configurations.

In some examples, transmitting the message requesting the update to the one or more training data collection configurations is based on the performed measurements satisfying one or more criteria.

In some examples, the training data collection configuration component 725 is capable of, configured to, or operable to support a means for pausing the one or more training data collection configurations based at least on the performed measurements satisfying the one or more criteria.

In some examples, the message requesting the update indicates that the performed measurements satisfy the one or more criteria.

In some examples, the one or more criteria include satisfaction of one or more measurement thresholds associated with the performed measurements, identification of a redundancy associated with the performed measurements, satisfaction of a power consumption threshold, satisfaction of a power memory threshold, or any combination thereof.

In some examples, the message requesting the update includes an UCI message, a MAC-CE, or a RRC message.

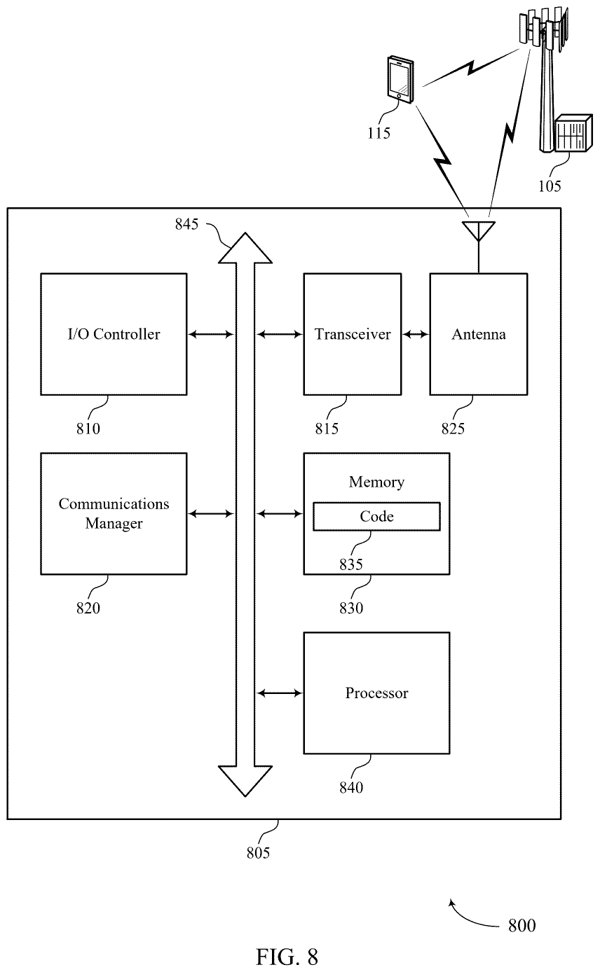

FIG. 8 shows a diagram of a system 800 including a device 805 that supports updating training reference signal configurations in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting updating training reference signal configurations). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving first signaling indicating one or more training data collection configurations for performing measurements, logging measurements, reporting measurements, or any combination thereof. The communications manager 820 is capable of, configured to, or operable to support a means for performing the measurements on one or more configured reference signals in accordance with the one or more training data collection configurations in accordance with the one or more training data collection configurations. The communications manager 820 is capable of, configured to, or operable to support a means for transmitting a message requesting an update to the one or more training data collection configurations based on the performed measurements. The communications manager 820 is capable of, configured to, or operable to support a means for receiving, in response to the message, second signaling indicating for the UE to pause the one or more training data collection configurations, indicating for the UE to initiate the one or more training data collection configurations, or indicating the update to the one or more training data collection configurations.

By including or configuring the communications manager 820 in accordance with examples as described herein, the device 805 may support techniques for updating a training data collection configuration, which may result in improved communication reliability, more efficient utilization of communication resources, improved coordination between devices, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of updating training reference signal configurations as described herein, or the at least one processor 840 and the at least one memory 830 may be otherwise configured to, individually or collectively, perform or support such operations.

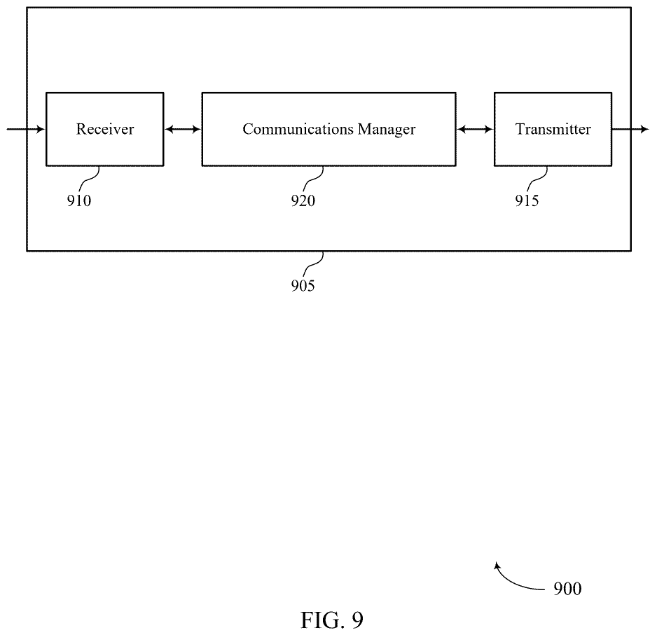

FIG. 9 shows a block diagram 900 of a device 905 that supports updating training reference signal configurations in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of updating training reference signal configurations as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for outputting, to a UE, first signaling indicating one or more training data collection configurations for performing measurements, logging measurements, reporting measurements, or any combination thereof. The communications manager 920 is capable of, configured to, or operable to support a means for obtaining a report indicating one or more measurements performed on one or more configured reference signals in accordance with the one or more training data collection configurations. The communications manager 920 is capable of, configured to, or operable to support a means for outputting second signaling indicating for the UE to pause the one or more training data collection configurations, indicating for the UE to initiate the one or more training data collection configurations, or indicating an update to the one or more training data collection configurations.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for updating a training data collection configuration, which may result in more efficient utilization of communication resources.

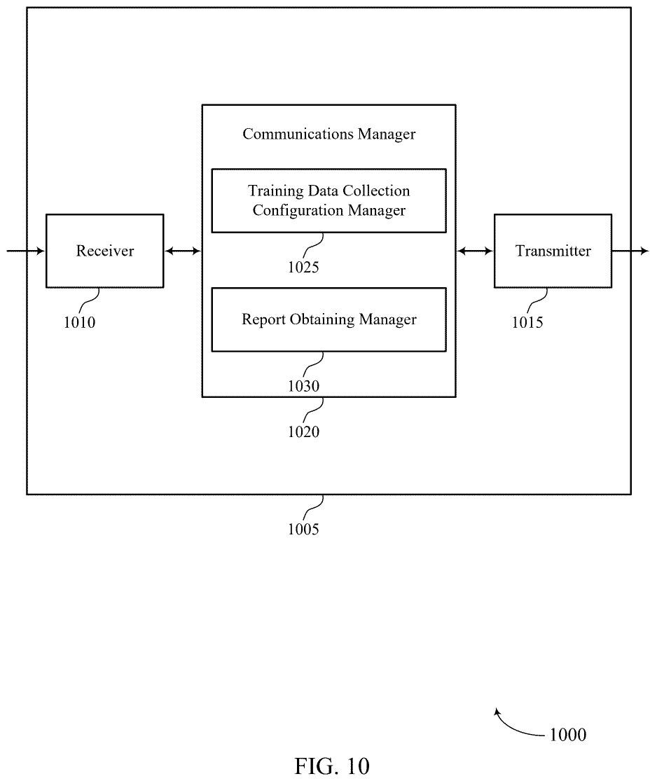

FIG. 10 shows a block diagram 1000 of a device 1005 that supports updating training reference signal configurations in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of updating training reference signal configurations as described herein. For example, the communications manager 1020 may include a training data collection configuration manager 1025 a report obtaining manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The training data collection configuration manager 1025 is capable of, configured to, or operable to support a means for outputting, to a UE, first signaling indicating one or more training data collection configurations for performing measurements, logging measurements, reporting measurements, or any combination thereof. The report obtaining manager 1030 is capable of, configured to, or operable to support a means for obtaining a report indicating one or more measurements performed on one or more configured reference signals in accordance with the one or more training data collection configurations. The training data collection configuration manager 1025 is capable of, configured to, or operable to support a means for outputting second signaling indicating for the UE to pause the one or more training data collection configurations, indicating for the UE to initiate the one or more training data collection configurations, or indicating an update to the one or more training data collection configurations.

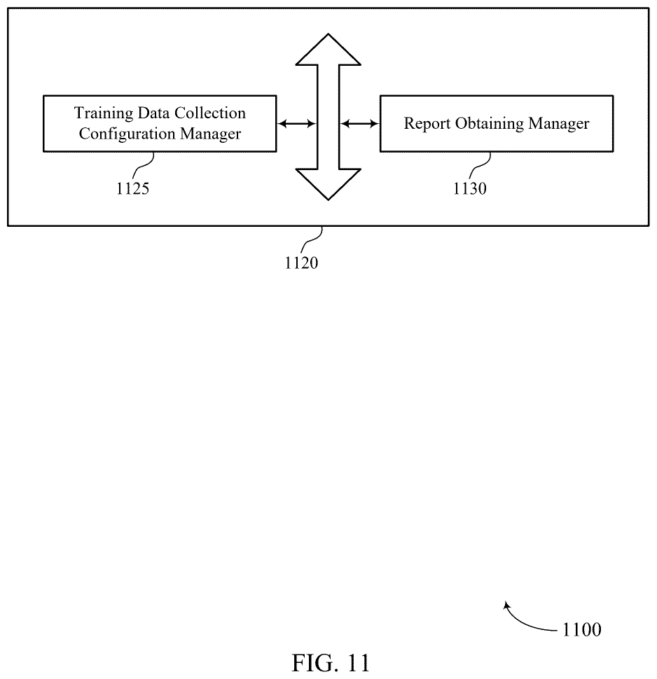

FIG. 11 shows a block diagram 1100 of a communications manager 1120 that supports updating training reference signal configurations in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of updating training reference signal configurations as described herein. For example, the communications manager 1120 may include a training data collection configuration manager 1125 a report obtaining manager 1130, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The training data collection configuration manager 1125 is capable of, configured to, or operable to support a means for outputting, to a UE, first signaling indicating one or more training data collection configurations for performing measurements, logging measurements, reporting measurements, or any combination thereof. The report obtaining manager 1130 is capable of, configured to, or operable to support a means for obtaining a report indicating one or more measurements performed on one or more configured reference signals in accordance with the one or more training data collection configurations. In some examples, the training data collection configuration manager 1125 is capable of, configured to, or operable to support a means for outputting second signaling indicating for the UE to pause the one or more training data collection configurations, indicating for the UE to initiate the one or more training data collection configurations, or indicating an update to the one or more training data collection configurations.

In some examples, the one or more training data collection configurations include one or more measurement configurations, one or more logging configuration for storing measurements based on one or more measurement configurations, one or more reporting configurations associated with determining a suitability of the one or more measurement configurations or a quality of the stored measurements, or any combination thereof.

In some examples, the one or measurement configurations include one or more CSI-RS resources, one or more CSI-RS resource sets, one or more SS/PBSCH resources, one or more SS/PBSCH resource sets, one or more cells, one or more frequency resources, one or more positioning reference signals, or any combination thereof.

In some examples, the update to the one or more training data collection configurations includes a change associated with the one or more measurement configurations, a change associated with the one or more logging configurations, a change associated with the one or more reporting configurations, or any combination thereof.

In some examples, the second signaling indicates one or more indicators corresponding to the one or more measurement configurations.

In some examples, outputting the second signaling is based on the performed measurements satisfying one or more criteria.

In some examples, the one or more criteria include satisfaction of one or more measurement thresholds associated with the performed measurements, identification of a redundancy associated with the performed measurements, satisfaction of a power consumption threshold, satisfaction of a power memory threshold, or any combination thereof.

In some examples, the second signaling includes a DCI message, a MAC-CE, or a RRC message.

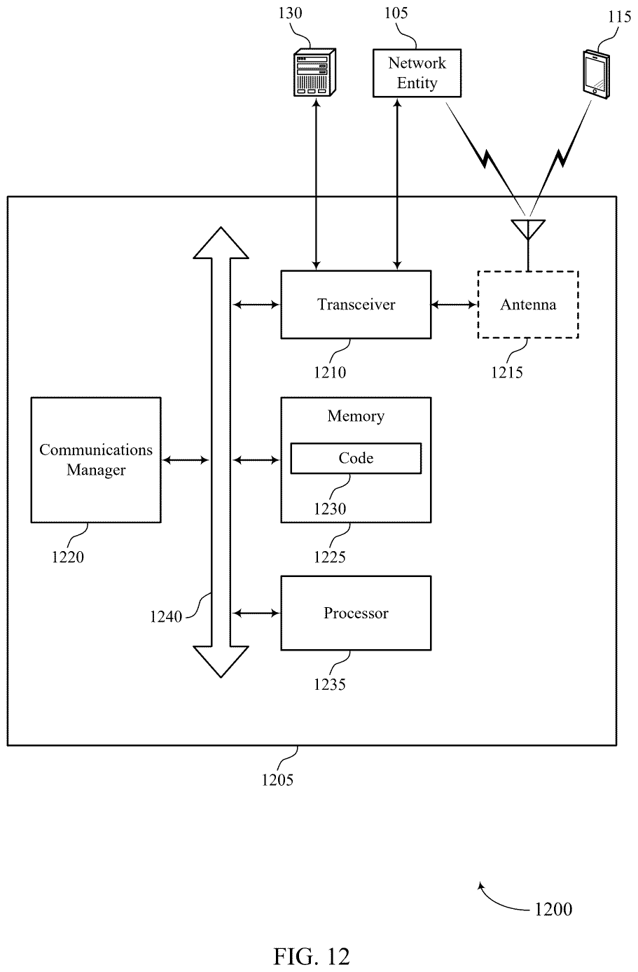

FIG. 12 shows a diagram of a system 1200 including a device 1205 that supports updating training reference signal configurations in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting updating training reference signal configurations). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for outputting, to a UE, first signaling indicating one or more training data collection configurations for performing measurements, logging measurements, reporting measurements, or any combination thereof. The communications manager 1220 is capable of, configured to, or operable to support a means for obtaining a report indicating one or more measurements performed on one or more configured reference signals in accordance with the one or more training data collection configurations. The communications manager 1220 is capable of, configured to, or operable to support a means for outputting second signaling indicating for the UE to pause the one or more training data collection configurations, indicating for the UE to initiate the one or more training data collection configurations, or indicating an update to the one or more training data collection configurations.

By including or configuring the communications manager 1220 in accordance with examples as described herein, the device 1205 may support techniques for updating a training data collection configuration, which may result in improved communication reliability, more efficient utilization of communication resources, improved coordination between devices, and improved utilization of processing capability.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of updating training reference signal configurations as described herein, or the at least one processor 1235 and the at least one memory 1225 may be otherwise configured to, individually or collectively, perform or support such operations.

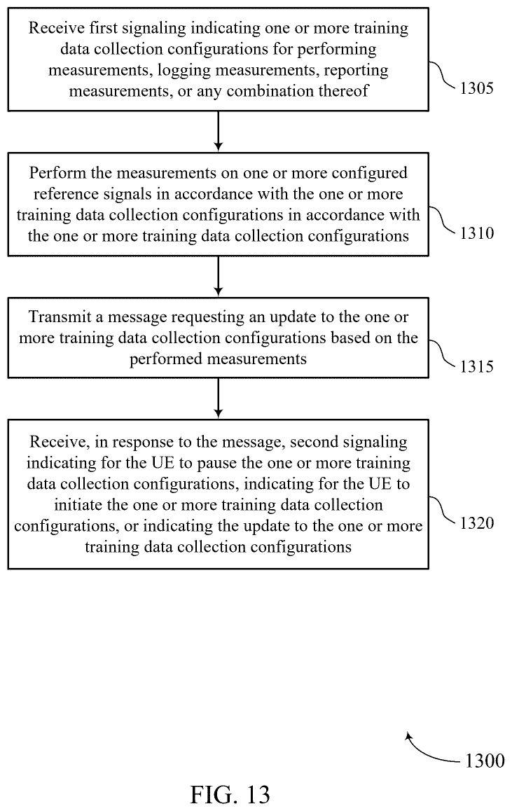

FIG. 13 shows a flowchart illustrating a method 1300 that supports updating training reference signal configurations in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving first signaling indicating one or more training data collection configurations for performing measurements, logging measurements, reporting measurements, or any combination thereof. The operations of 1305 may be performed in accordance with examples as disclosed herein. In some examples, aspects of the operations of 1305 may be performed by a training data collection configuration component 725 as described with reference to FIG. 7.

At 1310, the method may include performing the measurements on one or more configured reference signals in accordance with the one or more training data collection configurations in accordance with the one or more training data collection configurations. The operations of 1310 may be performed in accordance with examples as disclosed herein. In some examples, aspects of the operations of 1310 may be performed by a measurement performing component 730 as described with reference to FIG. 7.

At 1315, the method may include transmitting a message requesting an update to the one or more training data collection configurations based on the performed measurements. The operations of 1315 may be performed in accordance with examples as disclosed herein. In some examples, aspects of the operations of 1315 may be performed by an update request component 735 as described with reference to FIG. 7.

At 1320, the method may include receiving, in response to the message, second signaling indicating for the UE to pause the one or more training data collection configurations, indicating for the UE to initiate the one or more training data collection configurations, or indicating the update to the one or more training data collection configurations. The operations of 1320 may be performed in accordance with examples as disclosed herein. In some examples, aspects of the operations of 1320 may be performed by a training data collection configuration component 725 as described with reference to FIG. 7.

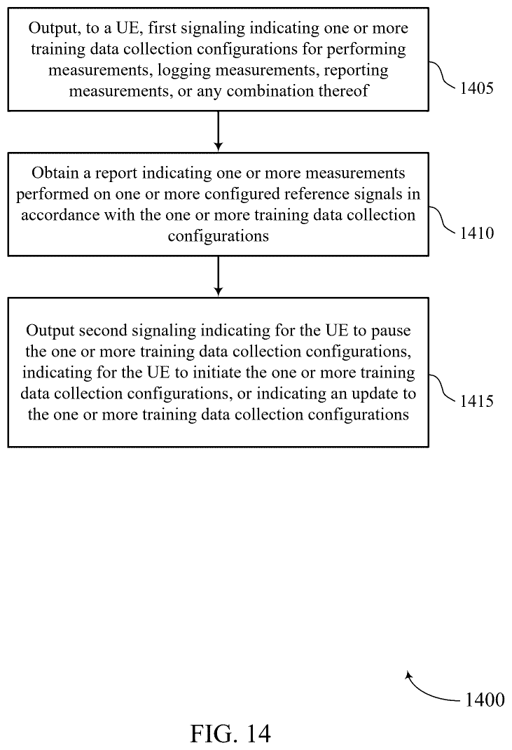

FIG. 14 shows a flowchart illustrating a method 1400 that supports updating training reference signal configurations in accordance with one or more aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include outputting, to a UE, first signaling indicating one or more training data collection configurations for performing measurements, logging measurements, reporting measurements, or any combination thereof. The operations of 1405 may be performed in accordance with examples as disclosed herein. In some examples, aspects of the operations of 1405 may be performed by a training data collection configuration manager 1125 as described with reference to FIG. 11.

At 1410, the method may include obtaining a report indicating one or more measurements performed on one or more configured reference signals in accordance with the one or more training data collection configurations. The operations of 1410 may be performed in accordance with examples as disclosed herein. In some examples, aspects of the operations of 1410 may be performed by a report obtaining manager 1130 as described with reference to FIG. 11.

At 1415, the method may include outputting second signaling indicating for the UE to pause the one or more training data collection configurations, indicating for the UE to initiate the one or more training data collection configurations, or indicating an update to the one or more training data collection configurations. The operations of 1415 may be performed in accordance with examples as disclosed herein. In some examples, aspects of the operations of 1415 may be performed by a training data collection configuration manager 1125 as described with reference to FIG. 11.

The following provides an overview of aspects of the present disclosure:
Aspect 1: A method for wireless communications by a UE, comprising: receiving first signaling indicating one or more training data collection configurations for performing measurements, logging measurements, reporting measurements, or any combination thereof; performing the measurements on one or more configured reference signals in accordance with the one or more training data collection configurations in accordance with the one or more training data collection configurations; transmitting a message requesting an update to the one or more training data collection configurations based at least in part on the performed measurements; and receiving, in response to the message, second signaling indicating for the UE to pause the one or more training data collection configurations, indicating for the UE to initiate the one or more training data collection configurations, or indicating the update to the one or more training data collection configurations.
Aspect 2: The method of aspect 1, wherein the one or more training data collection configurations include one or more measurement configurations, one or more logging configurations for storing measurements based on one or more measurement configurations, one or more reporting configurations associated with determining a suitability of the one or more measurement configurations or a quality of the stored measurements, or any combination thereof.
Aspect 3: The method of aspect 2, wherein the one or measurement configurations include one or more CSI-RS resources, one or more CSI-RS resource sets, one or more SS/PBSCH resources, one or more SS/PBSCH resource sets, one or more cells, one or more frequency resources, one or more positioning reference signals, or any combination thereof.
Aspect 4: The method of any of aspects 2 through 3, wherein the update to the one or more training data collection configurations comprises a change associated with the one or more measurement configurations, a change associated with the one or more logging configurations, a change associated with the one or more reporting configurations, or any combination thereof.
Aspect 5: The method of aspect 4, wherein the message requesting the update indicates one or more indicators corresponding to the one or more measurement configurations.
Aspect 6: The method of any of aspects 1 through 5, wherein transmitting the message requesting the update to the one or more training data collection configurations is based at least in part on the performed measurements satisfying one or more criteria.
Aspect 7: The method of aspect 6, further comprising: pausing the one or more training data collection configurations based at least on the performed measurements satisfying the one or more criteria.
Aspect 8: The method of any of aspects 6 through 7, wherein the message requesting the update indicates that the performed measurements satisfy the one or more criteria.
Aspect 9: The method of any of aspects 6 through 8, wherein the one or more criteria comprise satisfaction of one or more measurement thresholds associated with the performed measurements, identification of a redundancy associated with the performed measurements, satisfaction of a power consumption threshold, satisfaction of a power memory threshold, or any combination thereof.
Aspect 10: The method of any of aspects 1 through 9, wherein the message requesting the update comprises an UCI message, a MAC-CE, or a RRC message.
Aspect 11: A method for wireless communications by a network entity, comprising: outputting, to a UE, first signaling indicating one or more training data collection configurations for performing measurements, logging measurements, reporting measurements, or any combination thereof; obtaining a report indicating one or more measurements performed on one or more configured reference signals in accordance with the one or more training data collection configurations; and outputting second signaling indicating for the UE to pause the one or more training data collection configurations, indicating for the UE to initiate the one or more training data collection configurations, or indicating an update to the one or more training data collection configurations.
Aspect 12: The method of aspect 11, wherein the one or more training data collection configurations include one or more measurement configurations, one or more logging configuration for storing measurements based on one or more measurement configurations, one or more reporting configurations associated with determining a suitability of the one or more measurement configurations or a quality of the stored measurements, or any combination thereof.
Aspect 13: The method of aspect 12, wherein the one or measurement configurations include one or more CSI-RS resources, one or more CSI-RS resource sets, one or more SS/PBSCH resources, one or more SS/PBSCH resource sets, one or more cells, one or more frequency resources, one or more positioning reference signals, or any combination thereof.
Aspect 14: The method of any of aspects 12 through 13, wherein the update to the one or more training data collection configurations comprises a change associated with the one or more measurement configurations, a change associated with the one or more logging configurations, a change associated with the one or more reporting configurations, or any combination thereof.
Aspect 15: The method of any of aspects 12 through 14, wherein the second signaling indicates one or more indicators corresponding to the one or more measurement configurations.
Aspect 16: The method of any of aspects 11 through 15, wherein outputting the second signaling is based at least in part on the performed measurements satisfying one or more criteria.
Aspect 17: The method of aspect 16, wherein the one or more criteria comprise satisfaction of one or more measurement thresholds associated with the performed measurements, identification of a redundancy associated with the performed measurements, satisfaction of a power consumption threshold, satisfaction of a power memory threshold, or any combination thereof.
Aspect 18: The method of any of aspects 11 through 17, wherein the second signaling comprises a DCI message, a MAC-CE, or a RRC message.
Aspect 19: A UE for wireless communications, comprising one or more memories storing processor-executable code, and one or more processors coupled with the one or more memories and individually or collectively operable to execute the code to cause the UE to perform a method of any of aspects 1 through 10.
Aspect 20: A UE for wireless communications, comprising at least one means for performing a method of any of aspects 1 through 10.
Aspect 21: A non-transitory computer-readable medium storing code for wireless communications, the code comprising instructions executable by one or more processors to perform a method of any of aspects 1 through 10.
Aspect 22: A network entity for wireless communications, comprising one or more memories storing processor-executable code, and one or more processors coupled with the one or more memories and individually or collectively operable to execute the code to cause the network entity to perform a method of any of aspects 11 through 18.
Aspect 23: A network entity for wireless communications, comprising at least one means for performing a method of any of aspects 11 through 18.
Aspect 24: A non-transitory computer-readable medium storing code for wireless communications, the code comprising instructions executable by one or more processors to perform a method of any of aspects 11 through 18.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive first signaling indicating one or more training data collection configurations for performing measurements, logging measurements, reporting measurements, or any combination thereof;
perform the measurements on one or more configured reference signals in accordance with the one or more training data collection configurations in accordance with the one or more training data collection configurations;
transmit a message requesting an update to the one or more training data collection configurations based at least in part on the performed measurements; and
receive, in response to the message, second signaling indicating for the UE to pause the one or more training data collection configurations, indicating for the UE to initiate the one or more training data collection configurations, or indicating the update to the one or more training data collection configurations.

2. The UE of claim 1, wherein the one or more training data collection configurations include one or more measurement configurations, one or more logging configurations for storing measurements based on the one or more measurement configurations, one or more reporting configurations associated with determining a suitability of the one or more measurement configurations or a quality of the stored measurements, or any combination thereof.

3. The UE of claim 2, wherein the one or measurement configurations include one or more channel state information reference signal resources, one or more channel state information reference signal resource sets, one or more synchronization signal or physical broadcast shared channel resources, one or more synchronization signal or physical broadcast shared channel resource sets, one or more cells, one or more frequency resources, one or more positioning reference signals, or any combination thereof.

4. The UE of claim 2, wherein the update to the one or more training data collection configurations comprises a change associated with the one or more measurement configurations, a change associated with the one or more logging configurations, a change associated with the one or more reporting configurations, or any combination thereof.

5. The UE of claim 4, wherein the message requesting the update indicates one or more indicators corresponding to the one or more measurement configurations.

6. The UE of claim 1, wherein transmitting the message requesting the update to the one or more training data collection configurations is based at least in part on the performed measurements satisfying one or more criteria.

7. The UE of claim 6, wherein the one or more processors are individually or collectively further operable to execute the code to cause the UE to:
pause the one or more training data collection configurations based at least on the performed measurements satisfying the one or more criteria.

8. The UE of claim 6, wherein the message requesting the update indicates that the performed measurements satisfy the one or more criteria.

9. The UE of claim 6, wherein the one or more criteria comprise satisfaction of one or more measurement thresholds associated with the performed measurements, identification of a redundancy associated with the performed measurements, satisfaction of a power consumption threshold, satisfaction of a power memory threshold, or any combination thereof.

10. The UE of claim 1, wherein the message requesting the update comprises an uplink control information message, a medium access control-control element, or a radio resource control message.

11. A method for wireless communications by a user equipment (UE), comprising:
receiving first signaling indicating one or more training data collection configurations for performing measurements, logging measurements, reporting measurements, or any combination thereof;
performing the measurements on one or more configured reference signals in accordance with the one or more training data collection configurations in accordance with the one or more training data collection configurations;
transmitting a message requesting an update to the one or more training data collection configurations based at least in part on the performed measurements; and
receiving, in response to the message, second signaling indicating for the UE to pause the one or more training data collection configurations, indicating for the UE to initiate the one or more training data collection configurations, or indicating the update to the one or more training data collection configurations.

12. The method of claim 11, wherein the one or more training data collection configurations include one or more measurement configurations, one or more logging configurations for storing measurements based on one or more measurement configurations, one or more reporting configurations associated with determining a suitability of the one or more measurement configurations or a quality of the stored measurements, or any combination thereof.

13. The method of claim 12, wherein the one or measurement configurations include one or more channel state information reference signal resources, one or more channel state information reference signal resource sets, one or more synchronization signal or physical broadcast shared channel resources, one or more synchronization signal or physical broadcast shared channel resource sets, one or more cells, one or more frequency resources, one or more positioning reference signals, or any combination thereof.

14. The method of claim 12, wherein the update to the one or more training data collection configurations comprises a change associated with the one or more measurement configurations, a change associated with the one or more logging configurations, a change associated with the one or more reporting configurations, or any combination thereof.

15. The method of claim 14, wherein the message requesting the update indicates one or more indicators corresponding to the one or more measurement configurations.

16. The method of claim 11, wherein transmitting the message requesting the update to the one or more training data collection configurations is based at least in part on the performed measurements satisfying one or more criteria.

17. The method of claim 16, further comprising:
pausing the one or more training data collection configurations based at least on the performed measurements satisfying the one or more criteria.

18. The method of claim 16, wherein the message requesting the update indicates that the performed measurements satisfy the one or more criteria.

19. The method of claim 16, wherein the one or more criteria comprise satisfaction of one or more measurement thresholds associated with the performed measurements, identification of a redundancy associated with the performed measurements, satisfaction of a power consumption threshold, satisfaction of a power memory threshold, or any combination thereof.

20. A non-transitory computer-readable medium storing code for wireless communications at a user equipment (UE), the code comprising instructions executable by one or more processors to:
receive first signaling indicating one or more training data collection configurations for performing measurements, logging measurements, reporting measurements, or any combination thereof;
perform the measurements on one or more configured reference signals in accordance with the one or more training data collection configurations in accordance with the one or more training data collection configurations;
transmit a message requesting an update to the one or more training data collection configurations based at least in part on the performed measurements; and
receive, in response to the message, second signaling indicating for the UE to pause the one or more training data collection configurations, indicating for the UE to initiate the one or more training data collection configurations, or indicating the update to the one or more training data collection configurations.
